(19) United States
(12) Patent Application Publication
(10) Pub. No.: US 2025/0122635 A1
(43) Pub. Date: Apr. 17, 2025

(54) ELECTROLYZER WITH PULSE WIDTH MODULATOR

(71) Applicant: Davy Gas Inc., Cincinnati, OH (US)

(72) Inventors: James M. Oros, Asheville, NC (US); Patrick J. Pelch, Meridian, ID (US); Michael A. Fallavollita, Schertz, TX (US)

(21) Appl. No.: 18/912,362

(22) Filed: Oct. 10, 2024

Related U.S. Application Data
(60) Provisional application No. 63/589,575, filed on Oct. 11, 2023.

(51) Int. Cl. C25B 15/02; C25B 1/04; C25B 9/19; C25B 9/65; C25B 15/023; C25B 15/031

(52) U.S. Cl. CPC C25B 15/02; C25B 1/04; C25B 9/19; C25B 9/65; C25B 15/023; C25B 15/031

(57) ABSTRACT

Disclosed herein are components of an electrolysis system and components and methods of operation thereof to improve electrolysis operations. The electrolysis system includes a pulse width modulation control system that adjusts voltage and current applied to an electrolytic cell by modulating a duty cycle of a high frequency waveform. The voltage and current are adjusted based on data provided by one or more feedback loops that monitor performance characteristics of the electrolyzer.

### CROSS REFERENCE TO RELATED APPLICATION

This application claims the benefit of U.S. Provisional Application No. 63/589,575, filed Oct. 11, 2023, which is hereby incorporated in its entirety herein.

### BACKGROUND

### Technical Field

This disclosure relates generally to electrolyzers that produce gas from liquid, and more specifically relates to electrolyzers that reduce bubble buildup and promote bubble propagation.

### Description of the Related Art

An electrolyzer is a device capable of splitting water molecules into their constituent oxygen and hydrogen atoms. Known electrolyzers include a conductive electrode stack separated by a membrane. A voltage generates an electric current in the water, breaking the water down into its components of hydrogen and oxygen. The oxygen generated may be released into the atmosphere or stored for use (e.g., as a medical or industrial gas). The hydrogen may be stored as a compressed gas or liquefied for use (e.g., in hydrogen fuel cells to power transport vehicles).

Known electrolyzers may be part of a larger system including pumps, power generation/delivery, a gas separator, storage tanks, etc. There are different types of known electrolyzers including: alkaline; proton exchange membrane (PEM); anion exchange membrane (AEM); and solid oxide electrolysis cell (SOEC).

Alkaline electrolyzers are the oldest, most proven, and widely used type of electrolyzer for producing hydrogen gas from water as a clean and renewable energy source. Known alkaline electrolyzers include a liquid electrolyte solution (e.g., potassium/sodium hydroxide and water). Hydrogen is produced in a cell that includes an anode, a cathode, and a membrane. Multiple cells may be positioned in series to form a “stack” thereby increasing hydrogen and oxygen production. When current is applied to the cell/stack, hydroxide ions move through the liquid electrolyte solution from the cathode to the anode of each cell, generating bubbles of hydrogen gas on the cathode side of the electrolyzer and oxygen gas on the anode side. The efficiency and performance of the electrolysis process depend on various factors, including the cell design, the type and concentration of electrolyte, the applied voltage and current, and the temperature.

Known PEM electrolyzers include a proton exchange membrane and a solid polymer electrolyte. The application of electric current splits water into hydrogen and oxygen. The hydrogen protons pass through the membrane to form hydrogen gas on the cathode side.

Known AEM electrolyzers utilize a semipermeable membrane that conducts hydroxide ions. Like a proton-exchange membrane (PEM), the membrane separates the products, provides electrical insulation between electrodes, and conducts ions. Unlike PEM, AEM conducts hydroxide ions. One major advantage of AEM water electrolysis is that a high-cost noble metal catalyst is not required, and a low-cost transition metal catalyst may be used instead. AEM electrolysis is similar to alkaline water electrolysis, which uses a non-ion-selective separator instead of an anion-exchange membrane.

Known SOECs operate at a higher temperature (e.g., between 500 and 850° C.) than other known electrolyzers. Also referred to as high-temperature electrolysis (HTE) or steam electrolysis, a solid ceramic material serves as the electrolyte. Electrons from an external circuit combine with water at a cathode to form hydrogen gas and negatively charged ions. Oxygen then passes through the sliding ceramic membrane and reacts at an anode to form oxygen gas and generate electrons for the external circuit.

Other types of electrolyzers known but are typically not yet as efficient or cost-effective as those referenced above. For example, photoelectrolysis uses only sunlight to separate water molecules without the need for electricity.

One of the main challenges in alkaline electrolysis is control of the applied voltage and current to the cell. The applied voltage and current affect the electrolysis rate, the hydrogen evolution efficiency, and the electrolyte degradation. Known electrolyzers typically use constant voltage or current sources, which are often inefficient and unstable, leading to high energy consumption, low productivity, and unwanted side reactions.

### BRIEF SUMMARY

The present disclosure provides an improved electrolyzer that reduces bubble buildup, improves bubble propagation, lowers energy consumption and other operating costs, and reduces unwanted side reactions.

Direct current (DC) power is commonly used in electrolysis systems because it allows for a constant and predictable supply of current to the electrodes. However, this can result in inefficient bubble release and high energy consumption if the current density is not optimized. Embodiments of the disclosure employ pulse width modulation to control the current density in an electrolysis system powered by a DC power supply.

Using pulse width modulation to control the current density in an electrolysis system powered by direct current may reduce energy consumption while improving the efficiency of bubble release from the electrodes. The pulse width modulation allows the current to be applied in a more controlled and precise manner that results in the formation of smaller bubbles that are more easily released from the electrode surface.

Embodiments of electrolyzers described herein may extend the lifespan of the electrodes within the electrolyzer by reducing the formation of large bubbles. Larger bubbles may result in increased mechanical stress and damage to the electrode surface compared to smaller bubbles produces by the pulse width modulation described herein.

According to one embodiment, an electrolysis system includes an electrolyzer having a first electrode at least partially submerged in a liquid electrolyte, a second electrode at least partially submerged in the liquid electrolyte, a diaphragm positioned between the first electrode and the second electrode, and a housing that at least partially encloses the first electrode, the second electrode, the diaphragm, the liquid electrolyte, or any combination thereof.

The system includes one or more feedback loops that collect data corresponding to one or more performance characteristics of the electrolyzer, and a pulse width modulation controller electrically coupled to a power source, the first electrode, and the second electrode. The pulse width modulation controller adjusts power delivered to the first electrode and the second electrode based on data received from the one or more feedback loops. A difference in the electric charge of the first electrode and the second electrode is sufficient to cause a chemical reaction within the liquid electrolyte that results in the production of gas bubbles.

Additional embodiments described herein provide a method of electrolysis. The method includes at least partially submerging a first electrode of an electrolyzer and a second electrode of the electrolyzer in a liquid electrolyte, and delivering power to the electrolyzer, thereby inducing a flow of electrons from the first electrode to the second electrode. The method further includes inducing a chemical reaction in the liquid electrolyte, the chemical reaction generating bubbles of a first gas formed closer to the first electrode and further generating bubbles of a second gas formed closer to the second electrode, monitoring one or more performance characteristics of the electrolyzer, adjusting the power delivered to the electrolyzer with a pulse width modulation controller, thereby altering the one or more performance characteristics, and monitoring the one or more altered performance characteristics.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements and may have been solely selected for ease of recognition in the drawings.

FIG. 1 is a schematic view of a known electrolyzer, according to one embodiment.

FIG. 2 is a schematic view of an electrolysis system, according to one embodiment.

FIG. 3 is a schematic view of an electrolyzer, according to one embodiment.

### DETAILED DESCRIPTION

In the following description, certain specific details are set forth to provide a thorough understanding of various disclosed embodiments. However, one of ordinary skill in the relevant art will recognize that embodiments may be practiced without one or more of these specific details, or with other methods, components, materials, etc. In other instances, well-known structures associated with electrolyzers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For example, certain features of the disclosure which are described herein in the context of separate embodiments may also be provided in combination in a single embodiment. Conversely, various features of the disclosure that are described in the context of a single embodiment may also be provided separately or in any subcombination.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise. Reference herein to two elements “facing” or “facing toward” each other indicates that a straight line can be drawn from one of the elements to the other of the elements without contacting an intervening solid structure.

The term “aligned” as used herein in reference to two elements along a direction means a straight line that passes through one of the elements and that is parallel to the direction will also pass through the other of the two elements. The term “between” as used herein in reference to a first element being between a second element and a third element with respect to a direction means that the first element is closer to the second element as measured along the direction than the third element is to the second element as measured along the direction. The term “between” includes, but does not require that the first, second, and third elements be aligned along the direction.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein.

Aspects of the disclosure will now be described in detail with reference to the drawings, wherein like reference numbers refer to like elements throughout, unless specified otherwise. Certain terminology is used in the following description for convenience only and is not limiting. The term “plurality,” as used herein, means more than one. The term “at least a portion” of a structure includes the entirety of the structure.

The headings and Abstract of the Disclosure provided herein are for convenience only and do not interpret the scope or meaning of the embodiments.

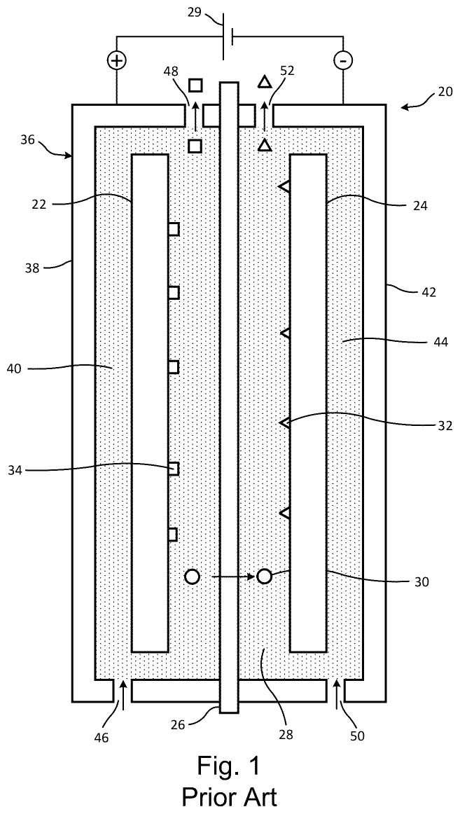

Referring to FIG. 1 a known electrolyzer 20 includes a first electrode 22 and a second electrode 24 separated by a diaphragm 26. The first electrode 22 and the second electrode 24 operate within a liquid electrolyte 28 (e.g., water, or an alkaline electrolyte solution such as potassium hydroxide or sodium hydroxide). The first electrode 22 and the second electrode 24 are electrically connected to a power supply 29 thereby positively charging the first electrode 22 (forming an anode) and negatively charging the second electrode 24 (forming a cathode). The first electrode 22 and the second electrode 24 are typically made of an electrical conducting material (e.g., nickel-based metals).

The diaphragm 26 is typically non-conductive to electrons, thereby preventing passage of electrons from the second electrode 24 to the first electrode 22 through the liquid electrolyte 28. The diaphragm 26 is typically porous with respect to charged ions 30 (e.g., hydroxide ions) within the liquid electrolyte 28 permitting passage of the charged ions through the diaphragm 26 (e.g., away from the second electrode 24 and toward the first electrode 22, or vice versa). The diaphragm 26 for the known electrolyzer 20 may be made of Zirfon, a composite of zirconia and Polysulfone.

Movement of the charged ions 30 from the second electrode 24, through the diaphragm 26, toward the first electrode 22, causes a chemical reaction within the liquid electrolyte 28. The specifics of the chemical reaction may vary based on the specific materials selected for one or more of the components of the known electrolyzer 20. For example, the chemical reaction may generate bubbles of hydrogen gas 32 and bubbles of oxygen gas 34.

The bubbles of oxygen gas 34 typically form on one of the electrodes (e.g., the first electrode 22) and the bubbles of hydrogen gas 32 typically form on the other of the electrodes (e.g., the second electrode 24). The bubbles of oxygen gas 34 and hydrogen gas 32 typically grow in size until offsetting gravity forces overcome the adhering force that secures the respective bubble to the respective electrode. Once the bubbles reach sufficient size, they detach from their respective electrode, exit the liquid electrolyte 28, and are collected (e.g., outside the known electrolyzer 20).

The known electrolyzer 20 may include a housing 36 that encloses one or more components of the electrolyzer 20. As shown, the housing 36 includes a first portion 38 that forms a first inner volume 40 in cooperation with the diaphragm 26. The housing 36 further includes a second portion 42 that forms a second inner volume 44 in cooperation with the diaphragm 26.

The known electrolyzer 20 includes a first entry passage 46, through which the liquid electrolyte 28 enters the first inner volume 40, and a first exit passage 48 through which a result of the chemical reaction (e.g., the bubbles of oxygen gas 34) exit the first inner volume 40. As shown, the first entry passage 46 and the first exit passage 48 are formed in the first portion 38. The known electrolyzer 20 includes a second entry passage 50, through which the liquid electrolyte 28 enters the second inner volume 44, and a second exit passage 52 through which a result of the chemical reaction (e.g., the bubbles of hydrogen gas 32) exit the second inner volume 44. As shown, the second entry passage 50 and the second exit passage 52 are formed in the second portion 42.

Electrolysis activity/efficiency is a function of surface area of the charged anode/cathode in the presence of the liquid electrolyte 28. Adherence of the bubbles of hydrogen gas 32 and oxygen gas 34 to surfaces of the first electrode 22 and the second electrode 24 diminishes throughput of the chemical reaction (e.g., the amount of bubbles/gas produced). Thus, an electrolyzer that is improved to promote release/liberation of gas bubbles that are in contact with the electrodes of the electrolyzer may result in an electrolyzer with improved efficiency.

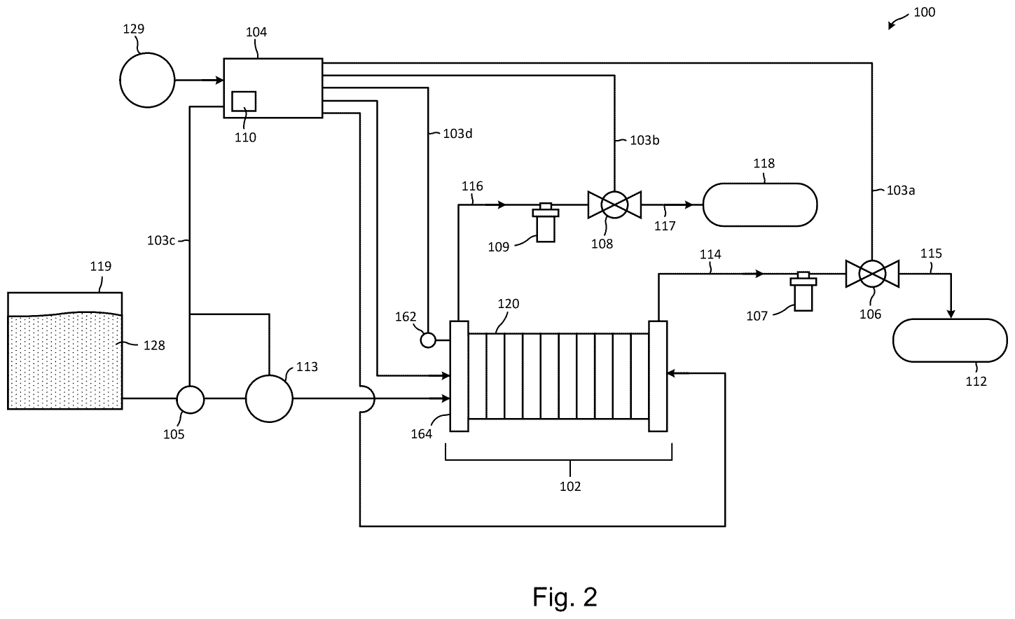

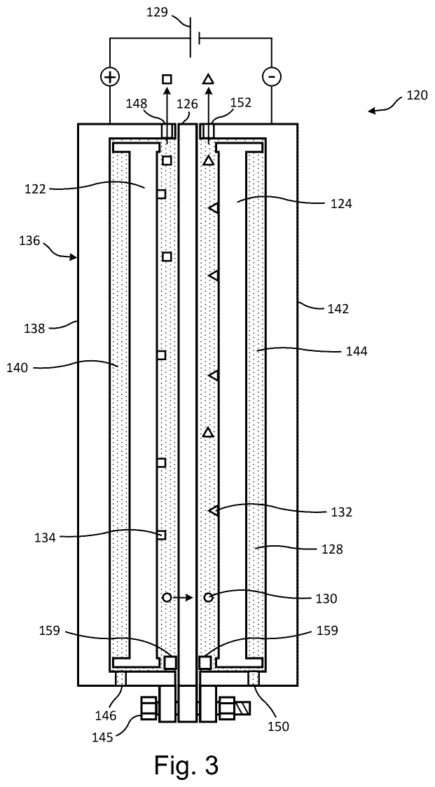

Referring to FIGS. 2 and 3, an electrolysis system 100 may include an electrolyzer 120. According to one embodiment, the electrolyzer 120 may be similar to the known electrolyzer 20, described above, such that the description of the known electrolyzer 20 is applicable to the electrolyzer 120.

As shown in FIG. 3, the electrolyzer 120 may include a first electrode 122 and a second electrode 124 separated by a diaphragm 126. At least one of the first electrode 122 and the second electrode 124 may operate within (i.e., may be at least partially submerged within) a liquid electrolyte 128 (e.g., water, or an alkaline electrolyte solution such as potassium hydroxide or sodium hydroxide). According to one embodiment, the first electrode 122 and the second electrode 124 may both be at least partially submerged within the same liquid electrolyte 128. According to one embodiment, the first electrode 122 may be at least partially submerged within the liquid electrolyte 128, and the second electrode may be at least partially submerged within another liquid (e.g., water). According to one embodiment, the first electrode 122 may be at least partially submerged within the liquid electrolyte 128, and the second electrode may be devoid of direct contact with any liquid.

The first electrode 122 and the second electrode 124 may be electrically connected to a power supply 129 that positively charges the first electrode 122, thereby forming an anode, and negatively charges the second electrode 124, thereby forming a cathode. The power supply 129 may be part of the electrolyzer 120 (e.g., a battery secured relative to the electrolyzer 120, or the power supply 129 may be external (i.e., separate from) the electrolyzer 120.

The first electrode 122 and the second electrode 124 are typically made of an electrical conducting material (e.g., nickel-based metals). According to one embodiment, one or both of the first electrode 122 and the second electrode 124 may be a mesh so as to increase the amount of surface area of the first electrode 122 and the second electrode 124 that is in contact with the liquid electrolyte 128. According to one embodiment, the first electrode 122, the second electrode 124, or both may made of a material so as to be conductive and non-consumable during electrolysis.

The diaphragm 126 may be non-conductive to electrons, thereby preventing passage of electrons from the second electrode 124 to the first electrode 122 through the liquid electrolyte 128. The diaphragm 126 may be porous with respect to the liquid electrolyte 128, to charged ions 130 (e.g., hydroxide ions) within the liquid electrolyte 128, or both, permitting passage of the liquid electrolyte 128 and/or the charged ions 130 through the diaphragm 126 (e.g., away from the second electrode 124 and toward the first electrode 122, or vice versa). According to one embodiment, the diaphragm 126 for the electrolyzer 120 may be made of a proton exchange membrane.

Movement of the charged ions 130 from the second electrode 124, through the diaphragm 126, toward the first electrode 122, facilitates a chemical reaction within the liquid electrolyte 128. The specifics of the chemical reaction may vary based on the specific materials selected for one or more of the components of the electrolyzer 120. For example, the chemical reaction may generate bubbles of hydrogen gas 132 and bubbles of oxygen gas 134. As shown in the illustrated embodiment, the bubbles of oxygen gas 134 may form on one of the electrodes (e.g., the first electrode 122, or the anode) and the bubbles of hydrogen gas 132 may form on the other of the electrodes (e.g., the second electrode 124, or the cathode). The diaphragm 126 may be electrolytic, such that the products formed during the chemical reaction are kept separate and are unable to pass through the diaphragm 126.

The electrolyzer 120 may include a housing 136 that encloses one or more components of the electrolyzer 120. As shown, the housing 136 may include a first portion 138 that encloses a first inner volume 140 in cooperation with the diaphragm 126. The housing 136 may further include a second portion 142 that encloses a second inner volume 144 in cooperation with the diaphragm 126. According to one embodiment, the first portion 138 and the second portion 142 may be secured by one or more fasteners 145 (e.g., bolts) inserted through corresponding fastener receiving holes (not shown) in the first portion 138 and the second portion 142. The diaphragm 126 may also include corresponding fastener receiving holes through which the one or more fasteners 145 are inserted to secure the diaphragm 126 relative to the housing 136.

The electrolyzer 120 (e.g., the housing 136) may include one or more supports that secure the first electrode 122 relative to the first portion 138 and that secure the second electrode 124 relative to the second portion 142. Alternatively, the housing 136 and the first electrode 122 and the second electrode 124 may have corresponding shapes that secure the first electrode 122 and the second electrode 124 relative to the housing 136 (e.g., as shown in FIG. 3).

The electrolyzer 120 may include an entry passage 146, through which the liquid electrolyte 128 enters the first inner volume 140, and a first exit passage 148 through which a result of the chemical reaction (e.g., the bubbles of oxygen gas 134) exits the first inner volume 140. As shown, the entry passage 146 and the first exit passage 148 may both be formed in the first portion 138. Alternatively, the first exit passage 148 may be formed in the first portion 138 and the entry passage 146 may be formed in the second portion 142.

According to one embodiment, the liquid electrolyte 128 may be able to flow into both the first inner volume 140 and the second inner volume 144 from the entry passage 146 (e.g., through the diaphragm 126 or an opening of the diaphragm 126). According to another embodiment, the entry passage 146 may be a first entry passage and the electrolyzer 120 may include a second entry passage 150, through which the liquid electrolyte 128 enters the second inner volume 144.

The electrolyzer 120 may include a second exit passage 152 through which a result of the chemical reaction (e.g., the bubbles of hydrogen gas 132) exit the second inner volume 144. As shown, the second entry passage 150 and the second exit passage 152 may be formed in the second portion 142.

As shown, the electrolyzer 120 may include one or more sensors 159 that collect data corresponding to one or more operating parameters of the electrolyzer 120, as described in further detail below. According to one embodiment, the data collected by the one or more sensors 159 relates to bubbles (e.g., number, amount, size) adhered/attached to one or both of the first electrode 122 and the second electrode 124.

As shown in FIG. 2, the system 100 may include a plurality of the electrolyzers 120 (e.g., positioned in series relative to one another to form an electrolyzer stack 102). The system 100 may include a pulse width modulation controller 104 that adjusts the power (e.g., voltage, current, or both) delivered to electrolyzer stack 102.

The pulse width modulation controller 104 may include a microcontroller or a digital signal processor that generates a high-frequency waveform (e.g., a square or rectangular pulse wave with a frequency between about 10 Hz to about 30 kHz). According to one embodiment, the pulse width modulation controller 104 modulates the duty cycle of the high frequency waveform to reduce the “on-time” percentage of the total cycle time of the high frequency waveform. The “on-time” percentage corresponds to the effective power (e.g., voltage and current) delivered to the electrolyzer stack 102. For example, increasing the “on-time” percentage may increase the average power delivered to the electrolyzer stack 102, while decreasing the “on-time” percentage may decrease the average power delivered to the electrolyzer stack 102.

As shown, the pulse width modulation controller 104 may be electrically coupled to the power supply 129, and may be electrically coupled to the electrolyzer 120 (e.g., the electrolyzer stack 102) so as to deliver power from the power supply 129, after the power has been modulated by the pulse width modulation controller 104, to the electrolyzer 120.

The system 100 may include one or more feedback loops that collect and/or analyze data corresponding to one or more operating parameters of the electrolyzer 120 (or electrolyzer stack 102), and transmit the data to the pulse width modulation controller 104. Upon receipt of the transmitted data, the pulse width modulation controller 104 may adjust the power being delivered to the electrolyzer 120.

Adjusting the high frequency waveform and thereby adjusting the power delivered to the electrolyzer stack 102 may impact: size and/or shape of bubbles formed as part of the chemical reaction within the liquid electrolyte 128; release rate of bubbles formed as part of the chemical reaction from the first electrode 122 and/or the second electrode 124; impedance within the electrolyzer 120; amount of gas produced by the chemical reaction; electrode potential; or any combination thereof.

A first feedback loop 103a of the one or more feedback loops may include a sensor (e.g., a flow meter) that measures the amount, flow rate, or other values of a gas produced as a result of the chemical reaction. According to one embodiment, the first feedback loop 103a may include a flow meter 106 that measures the amount, flow rate, or other values of a gas 114 formed on and released from the cathode (i.e., the second electrode 124). Thus, the flow meter 106 may be a hydrogen flow meter.

The system 100 may include a filter 107 (also referred to as a dryer) that removes unwanted particles from the gas 114 (e.g., after exiting the electrolyzer stack 102). The filter 107 may remove moisture or any other unwanted particles, allowing a filtered gas 115 (e.g., hydrogen) to pass through the filter 107. As shown the flow meter 106 may be positioned downstream from the filter 107 so as to improve accuracy of the measurement(s) (e.g., hydrogen flow rate) made by the flow meter 106.

The system 100 may include a storage vessel 112 that collects the gas 114. The storage vessel 112 may be positioned downstream of both the filter 107 and the flow meter 106 so as to collect only the filtered gas 115, and so as to not interfere with the measurements performed by the flow meter 106. The storage vessel 112 may be removable from the system 100 (e.g., when the storage vessel 112 is full it may be removed and replaced with an empty storage vessel). Alternatively, the system 100 may be devoid of the storage vessel 112 and may include conduits that deliver the filtered gas 115 to a desired destination.

According to one embodiment, a second feedback loop 103b of the one or more feedback loops may include a flow meter 108 that measures the amount, flow rate, or other values of a gas 116 formed on and released from the anode (i.e., the first electrode 122). Thus, the flow meter 108 may be an oxygen flow meter.

The system 100 may include a filter 109 (also referred to as a dryer) that removes unwanted particles from the gas 116 (e.g., after exiting the electrolyzer stack 102). According to one embodiment, the filter 109 may remove moisture or any other unwanted particles, allowing a filtered gas 117 (e.g., oxygen) to pass through the filter 109. As shown the flow meter 108 may be positioned downstream from the filter 109 so as to improve accuracy of the measurement(s) (e.g., oxygen flow rate) made by the flow meter 108.

The system 100 may include a storage vessel 118 that collects the gas 116. The storage vessel 118 may be positioned downstream of both the filter 109 and the flow meter 108 so as to collect only the filtered gas 117, and so as to not interfere with the measurements performed by the flow meter 108. The storage vessel 118 may be removable from the system 100 (e.g., when the storage vessel 118 is full it may be removed and replaced with an empty storage vessel). Alternatively, the system 100 may be devoid of the storage vessel 118 and may include conduits that deliver the filtered gas 117 to a desired destination.

The PWM controller 104 may include a datalogger 110 so as collect, store, and analyze data collected from each of the feedback loops 103a to 103d. The PWM controller 104 may be communicatively coupled to a computer or user interface so as to provide access to the collected and stored data on the datalogger 110 by a user of the computer.

The system 100 may include a reservoir 119 that contains a volume of the liquid electrolyte 128 (e.g., deionized water), and that is coupled to the electrolyzer stack 102 so as to provide a steady supply of the liquid electrolyte 128 to the electrolyzer stack 102 to facilitate the chemical reaction. A pump 113 may be included in the system 100 to move the liquid electrolyte 128 from the reservoir 119 to the electrolyzer 120. According to one embodiment, a third feedback loop 103c of the one or more feedback loops may include one or more sensors 105 that measures characteristics of the liquid electrolyte 128. The measured characteristics may include flow rate (e.g., via the pump 113), pH, temperature, etc.

A fourth feedback loop 103d of the one or more feedback loops may provide data corresponding to performance of the electrolyzer stack 102 (e.g., one or more of the individual electrolyzers 120). The fourth feedback loop 103d may include the one or more sensor 159 that measure/collect data related to bubbles (e.g., number, amount, size) formed by the chemical reaction, how many of the bubbles are adhered/attached to one or both of the first electrode 122 and the second electrode 124, impedance within the electrolyzer 120, electrode potential, or any combination thereof.

The system 100 (e.g., the pulse width modulation controller 104), or a user thereof, may collect and analyze multiple operating parameters of components of the system 100 and adjust the power delivered to the electrolyzer stack 102, thereby changing performance characteristics (e.g., rate of formation of the gas 114 and/or the gas 116, average bubble size within the electrolyzer 120 prior to release from the first electrode 122 and/or the second electrode 124, etc.).

The operating parameters of the system 100 may include: voltage-current curves; gas evolution rate; electrode potential; and bubble size and distribution. The voltage-current curve provides information on impedance and electrode performance, which may indicate the presence or absence of gas bubbles on the electrodes. If the impedance is stable and the voltage is close to the expected value, it suggests that the bubbles are being released from the electrodes successfully.

The gas evolution rate is measured by collecting and analyzing the gas produced during the chemical reaction process. If the gas production rate is steady and matches the expected value based on the electrode area and current density, it indicates that the bubbles are being released from the electrodes efficiently.

The electrode potential is measured using a reference electrode or a potentiometer to monitor the redox reactions on the electrode surface(s). If the electrode potential is stable and close to the expected value, this suggests that the gas bubbles are not interfering with the electrode reactions.

The bubble size and distribution can be visualized using high-speed imaging or microscopy techniques to observe the bubble behavior and transport. If the bubbles are small, uniform, and rapidly removed from the electrode surface, this may suggest that the waveform parameters are optimized for efficient bubble removal.

The pulse width modulation controller 104 enables fine tuning (i.e., small, incremental, adjustments) of the power delivered to the electrolyzer stack 102. By monitoring the performance characteristics and measuring changes in the performance characteristics, the system may optimize performance (e.g., bubble removal/release from the first electrode 122 and the second electrode 124). According to one embodiment, the pulse width modulation controller 104 makes adjustments in real time (e.g., in response to the most recent data provided by the one or more feedback loops).

Operation of the system 100 may begin with an initial amount of power being delivered to the electrolyzer stack 102. For example, the initial amount of power may be 100%. After an amount of time (e.g., once the system 100 has reached steady state), the pulse width modulation controller 104 may adjust (e.g., lower/decrease) the amount of power being delivered to the electrolyzer stack 102. The one or more feedback loops may monitor the performance characteristics of the system 100 (e.g., the first feedback loop 103a may measure a flow rate of hydrogen produced by the electrolyzer stack 102).

As the performance characteristics improve, the adjustment of the power being delivered to the electrolyzer stack 102 may continue until the one or more feedback loops indicate that the performance characteristics decrease. After receiving the data indicating a decrease in the performance characteristics, the pulse width modulation controller 104 may then cease further adjustment of the power being delivered to the electrolyzer stack 102. Optionally, the pulse width modulation controller 104 may reverse (e.g., raise/increase) the adjustment of power being delivered to the electrolyzer stack 102 from earlier.

The reversed adjustment of the power being delivered to the electrolyzer stack 102 may continue until the one or more feedback loops indicate that the performance characteristics decrease, at which point the process above may repeat until a steady state is reached. Even after reaching steady state, the one or more feedback loops may continue to monitor the performance characteristics enabling the pulse width modulation controller 104 to adjust (e.g., raise and/or lower) the power being delivered to the electrolyzer stack 102 to react to changing operational parameters (e.g., pH of the liquid electrolyte 128, temperature, degradation of the first electrode 122 and/or the second electrode 124).

Successful bubble (e.g., the bubbles of hydrogen gas 132 and the bubbles of oxygen gas 134) removal from the first electrode 122 and the second electrode 124 may be dependent on many different variables including electrical and fluid dynamic forces acting on the bubbles. Adjustment of the parameters of the high-frequency waveform generated by the pulse width modulation controller 104 may influence bubble size, bubble shape, and detachment of the bubbles, and may further affect impedance, gas production, and electrode potential of the electrolyzer 120. By measuring and analyzing these parameters, it is possible to assess the effectiveness of the waveform in promoting successful bubble removal.

Parameters of the high-frequency waveform generated by the pulse width modulation controller 104 may include: amplitude; frequency; duty cycle; rise and fall times; and phase shift. The amplitude of the square wave represents the maximum voltage applied to the electrodes. This parameter can range from a few to several hundred volts, depending on the system requirements and the electrode material.

The frequency of the square wave represents the number of cycles per second and can affect the bubble size and distribution, as well as the current density and heat generation. This parameter can range from a few Hz to several kHz, depending on the system dynamics and the desired waveform resolution, and may incorporate a pre-programmed variable frequency in lieu of a fixed frequency.

The duty cycle of the square wave represents the ratio of the ON time to the total period and can affect the average voltage and current density. This parameter can range from 0% to 100% (e.g., between about 50% to about 80%), depending on the desired waveform shape and the system requirements.

The rise and fall times of the square wave represent the time it takes for the voltage to reach its maximum or minimum values and can affect the waveform distortion and ringing. In most applications, the rise and fall times are typically in the range of a few microseconds to a few milliseconds. These parameters can be controlled by adjusting the circuit components and the waveform generation method.

The phase shift of the square wave represents the time delay between the voltage and current waveforms and can affect the power factor and the electrode reactions. This parameter may be adjusted using phase-locked loop (PLL) circuits or other synchronization techniques.

The system 100 provides several advantages over conventional electrolyzers. For example, the system 100 may reduce energy loss due to overvoltage and resistive heating, optimize current density and temperature within the electrolyzer 120, or both, which may result in higher operational energy efficiency and productivity by reducing energy loss due to overvoltage and resistive heating. The system 100 may produce a product with a higher quality (e.g., hydrogen gas with increased purity due to the minimization of the formation of unwanted byproducts (e.g., oxygen).

The system 100 may increase operational lifetime of the electrolyzer 120/electrolyzer stack 102 by preventing/limiting cell degradation due to overvoltage and current density fluctuations and by improving mass transfer and electrolyte circulation. Measuring throughput and flow rate of the liquid electrolyte 128 may also provide the basis for adjustments to operational parameters that result in increased production and efficiency for the system 100.

The system 100 may be more flexible and adaptable than conventional electrolyzers, the dynamic and real-time control of the electrolysis process enables the system to accommodate various input parameters and operating conditions. The system 100 may be cost-effective and scalable through its use of “off-the-shelf” electrolyzers/electrolyzer stacks. The conventional electrolyzers/electrolyzer stacks may be retrofit with the pulse width modulation controller 104 and one or more feedback loops to retrofit the conventional electrolyzers/electrolyzer stacks and integrate them into the system 100.

The optimum waveform for bubble release off the electrodes of any given electrolyzer may depend on several factors, such as electrode material, electrode geometry, type of electrolyte, current density, and desired performance characteristics. According to one embodiment, the system 100 (e.g., the pulse width modulation controller 104) may produce a waveform with a high frequency and a short duty cycle that results in efficient bubble release. A high-frequency waveform may promote the generation of small bubbles, which are easier to detach from the surface of the first electrode 122 and the second electrode 124 due to the lower buoyancy and surface tension of the smaller bubbles. A short duty cycle encourages bubble detachment from the first electrode 122 and the second electrode 124 before the bubbles coalesce or grow in size, which can hinder their detachment and cause increased resistance. In addition, a waveform with a short rise and fall time may reduce overpotential and energy consumption during the electrolysis process, as well as minimize the formation of undesirable byproducts. However, the system 100 may include lower frequencies, a longer duty cycle, or both according to the operation in which the system 100 is being used.

According to one embodiment, the pulse width modulation controller 104 may generate a waveform that is a square wave with a high frequency (typically in the range of 100 Hz to several kHz) and a short duty cycle (typically less than 50%). The parameters of the waveform may be continuously adjusted and optimized based on data received by the one or more feedback loops. A history or record of optimized waveform parameters correlating to specific electrolysis systems and performance requirements may be generated and stored (e.g., in the pulse width modulation controller 104).

The system 100 may include transparent materials that provide visibility to an interior (e.g., the inner volume 140 and/or the inner volume 144) of the electrolyzer 120. The one or more feedback loops (e.g., the fourth feedback loop 103d) may include one or more high speed imagers 162 positioned so as to visualize bubble behavior within the electrolyzer 120. According to one embodiment, the electrolyzer 120 and/or the electrolyzer stack 102 may include transparent end plates 164, and the one or more high speed imagers 162 may be positioned so as to visualize bubble behavior within the electrolyzer 120 through one or more of the transparent end plates 164.

Still referring to FIGS. 2 and 3, a method of electrolysis may include at least partially submerging the first electrode 122 and the second electrode 124 in a liquid electrolyte 128. The method may include positively charging the first electrode 122 and negatively charging the second electrode 124 (e.g., by connecting the electrolyzer 120 to the power supply 129). The method may include moving the charged ions within the liquid electrolyte 128 through the diaphragm 126 that is positioned between the first electrode 122 and the second electrode 124.

The method may include forming gas bubbles (e.g., the oxygen gas bubbles 134) on the first electrode 122 (or anode) and forming gas bubbles (e.g., the hydrogen gas bubbles 132) on the second electrode 124 (or cathode).

The method may further include collecting a first gas (e.g., oxygen) from the bubbles as the gas exits the first inner volume 140 (e.g., via a fitting, connector, or conduit), collecting a second gas (e.g., hydrogen) from the bubbles as the gas exits the second inner volume 144 (e.g., via a fitting, connector, or conduit), or collecting both the first gas and the second gas via respective ones of the fittings 184.

The method may include selecting one or more waveform parameters to test. According to one embodiment, the waveform parameters may include amplitude, frequency, duty cycle, rise and fall time, or any combination thereof. The method may include dynamically varying one or more of the waveform parameters (e.g., via the pulse width modulation controller 104).

The method may include monitoring gas bubbles generated at the first electrode 122, the second electrode 124, or both. Monitoring the gas bubbles may include visual inspection, gas chromatography, electrochemical impedance spectroscopy, or any combination thereof. Monitoring the gas bubbles may include measuring bubble size and detachment rate (e.g., using high-speed imaging or laser-based techniques).

The method may further include measuring electrolysis performance of the electrolyzer 120/electrolyzer stack 102. Measuring electrolysis performance may include measuring energy consumption, current efficiency, product yield, electrode polarization, or any combination thereof. Measuring electrolysis performance may include techniques such as galvanostatic control, cyclic voltammetry, chronopotentiometry, or any combination thereof.

The method may include analyzing data using statistical methods such as regression analysis, ANOVA, or DOE software. ANOVA (Analysis of Variance) and DOE (Design of Experiments) are statistical methods used to analyze experimental data and determine the most significant factors that affect the response variable (e.g., bubble release and electrolysis performance). ANOVA is a statistical technique that decomposes the total variation in a dataset into various sources of variation, such as between groups or within groups. ANOVA helps to determine whether the means of different groups are significantly different from each other, and which factors have the most significant effect on the response variable. DOE, conversely, is a systematic approach to designing experiments that efficiently explores a wide range of factors and their interactions. DOE involves selecting appropriate variables to study, setting up experimental conditions, and collecting data in a structured way. The data is then analyzed to identify the most significant factors and optimize the process performance.

The method may further include identifying the significant factors (e.g., ranking the significance of the factors) and their impact on bubble release and electrolysis performance. According to one embodiment, the method includes analyzing data to determine the most optimum waveform parameters that maximize bubble release and electrolysis performance. This analysis may be performed using optimization techniques such as response surface methodology or gradient descent.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The various embodiments described above can be combined to provide further embodiments.

Many of the methods described herein can be performed with variations. For example, many of the methods may include additional acts, omit some acts, and/or perform acts in a different order than as illustrated or described.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. An electrolysis system comprising:
an electrolyzer including a first electrode at least partially submerged in a liquid electrolyte, a second electrode at least partially submerged in the liquid electrolyte, a diaphragm positioned between the first electrode and the second electrode, and a housing that at least partially encloses the first electrode, the second electrode, the diaphragm, the liquid electrolyte, or any combination thereof;
one or more feedback loops that collect data corresponding to one or more performance characteristics of the electrolyzer; and
a pulse width modulation controller electrically coupled to a power source, the first electrode, and the second electrode, wherein the pulse width modulation controller adjusts power delivered to the first electrode and the second electrode based on data received from the one or more feedback loops,
wherein a difference in electric charge of the first electrode and the second electrode is sufficient to cause a chemical reaction within the liquid electrolyte that results in production of gas bubbles.

2. The electrolysis system of claim 1 wherein the one or more feedback loops includes a gas flow sensor.

3. The electrolysis system of claim 1 wherein the one or more performance characteristics of the electrolyzer includes number of gas bubbles generated, size of gas bubbles within the electrolyzer, amount of gas produced, or any combination thereof.

4. The electrolysis system of claim 3 wherein the one or more feedback loops includes a first feedback loop that measures an amount of hydrogen produced by the electrolyzer, a second feedback loop that measures an amount of oxygen produced by the electrolyzer; and a third feedback loop that measures properties of gas bubbles within the electrolyzer.

5. The electrolysis system of claim 1 wherein the housing includes a transparent portion, and the one or more feedback loops includes a high-speed imager positioned so as to visualize bubble behavior within the electrolyzer through the transparent portion.

6. The electrolysis system of claim 1 wherein the electrolyzer is an alkaline electrolyzer and the liquid electrolyte includes an alkaline electrolyte solution.

7. A method of electrolysis, the method comprising:
at least partially submerging a first electrode of an electrolyzer and a second electrode of the electrolyzer in a liquid electrolyte;
delivering power to the electrolyzer, thereby inducing a flow of electrons from the first electrode to the second electrode;
inducing a chemical reaction in the liquid electrolyte, the chemical reaction generating bubbles of a first gas formed closer to the first electrode and further generating bubbles of a second gas formed closer to the second electrode;
monitoring one or more performance characteristics of the electrolyzer;
adjusting the power delivered to the electrolyzer with a pulse width modulation controller, thereby altering the one or more performance characteristics; and
monitoring the one or more altered performance characteristics.

8. The method of claim 7 wherein one or more feedback loops monitor the one or more performance characteristics of the electrolyzer.

9. The method of claim 8 wherein the one or more performance characteristics include number of gas bubbles generated, size of gas bubbles within the electrolyzer, amount of gas produced, or any combination thereof.

10. The method of claim 9 wherein the power delivered to the electrolyzer is adjusted based on data received by the pulse width modulation controller, and the data corresponds to the one or more performance characteristics.

11. The method of claim 7 wherein the power delivered to the electrolyzer is adjusted based on data received by the pulse width modulation controller, and the data corresponds to pH of the liquid electrolyte.

12. The method of claim 7 wherein adjusting the power delivered to the electrolyzer includes adjusting a duty cycle of the pulse width modulation controller.

13. The method of claim 12 further comprising:
generating a waveform with a frequency between about 10 Hz to about 30 kHz; and
adjusting the frequency of the waveform thereby modulating the duty cycle of the waveform.

14. The method of claim 13 wherein the waveform is a square pulse wave or a rectangular pulse wave.

15. The method of claim 13 wherein the pulse width modulation controller includes a microprocessor or a digital signal processor that adjusts the frequency of the waveform.
